(19) United States
(12) Patent Application Publication
(10) Pub. No.: US 2020/0175033 A1
(43) Pub. Date: Jun. 4, 2020

(54) DISTRIBUTED DECENTRALIZED MATCHING

(71) Applicant: International Business Machines Corporation, Armonk, NY (US)

(72) Inventors: Venkat Raghavan, Duluth, GA (US); Dinesh C. Verma, New Castle, NY (US)

(21) Appl. No.: 16/203,699

(22) Filed: Nov. 29, 2018

(51) Int. Cl. G06F 16/27; G06F 16/21; G06F 16/2457; G06Q 40/00; H04L 29/08

(52) U.S. Cl. CPC G06F 16/27; G06F 16/212; H04L 67/104; G06Q 40/12; G06F 16/24578

(57) ABSTRACT

Embodiments of the invention are directed to a computer-implemented method for distributed decentralized matching. A non-limiting example of the computer-implemented method comprises transmitting, through a peer-to-peer network, a self-describing service request to a plurality of service provider nodes. The method further comprises receiving, from at least one service provider node, a service offer response. The method further comprises retrieving a compatible schema between the service client node and the service provider node. The method further comprises displaying a list of each service offer response to a service client.

### BACKGROUND

The present invention generally relates to a distributed computer network and more specifically, to distributed decentralized matching.

Peer-to-peer networking uses a distributed computing architecture to separate tasks between a set of interconnected computer nodes. As opposed to a client-server model, a peer-to-peer network shares resources between nodes without a traditional central server. Computer nodes or terminals are connected to facilitate file transferring with having to communicate through a server. The terminals can be connected either locally though wiring or a universal serial bus (USB) cable or connected via the internet and span across large geographic areas.

As each of the nodes in the peer-to-peer network are equal participants, no central server is required to direct the network peers or facilitate transferring files. Each terminal of the peer-to-peer network acts as a mini-server, providing service to peers, but without having to maintain the overhead of the server in a client-server model. In addition, the peers of a peer-to-peer system also act as clients, consumers of service, of other systems in the network. Each node a peer-to-peer network can both a client and a server.

### SUMMARY

Embodiments of the present invention are directed to a computer-implemented method for distributed decentralized matching. A non-limiting example of the computer-implemented method comprises transmitting, through a peer-to-peer network, a self-describing service request to a plurality of service provider nodes. The method further comprises receiving, from at least one service provider node, a service offer response. The method further comprises retrieving a compatible schema between the service client node and the service provider node. The method further comprises displaying a list of each service offer response to a service client.

Embodiments of the present invention are further directed to a computer system for distributed decentralized matching. The computer system includes a memory and a hardware processor system communicatively coupled to the memory. The processor system is configured to perform the computer-implemented method.

Embodiments of the present invention are further directed to a computer program product for distributed decentralized matching. The computer product comprises a computer readable storage medium embodied with program instructions. The instructions are executable by a hardware processor; and cause the hardware processor to perform the computer-implemented method.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a computer system for use in implementing one or more embodiments of the present invention;

FIG. 2 depicts a block diagram of a peer-to-peer network for use in implementing one or more embodiments of the present invention;

FIG. 3 depicts a block diagrams of a blockchain or use in implementing one or more embodiments of the present invention;

FIG. 4 depicts a block diagram of a service client node connected to a peer-to-peer network for use in implementing one or more embodiments of the present invention;

FIG. 5 depicts a block diagram of a service provider node connected to a peer-to-peer network for use in implementing one or more embodiments of the present invention;

FIG. 6 depicts a block diagram of service client nodes and service provider nodes connected to a peer-to-peer network for use in implementing one or more embodiments of the present invention; and

FIG. 7 depicts a flow diagram of a method for executing a service request through a peer-to-peer network according to one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Online matchers or brokers are a common phenomenon on the internet. They provide a way to match people looking for some product or service (service clients) to the people providing that product or service (service providers). Conventional matchers/broker applications typically aggregate the supply and are instantiated on proprietary websites.

However, this conventional supply-centric approach to demand fulfillment poses several challenges. The matcher/broker provides the platform and the framework for negotiation between the service provider and the service client. In other words, the service clients who create the demand for the product or service have no ability to deviate from the methods of advertising, interacting, and transacting with service providers from the methods provided by the matcher/broker.

Furthermore, in conventional matchers/broker applications, the matchers/brokers control any results from search inquiries of the service clients. For example, the matcher/broker decides which providers are returned to a client, the order upon which the providers are returned, and the criteria for matching a service client with a provider. These decisions by the matcher/broker may not be related to the service client's best interest, rather the results could be based upon matcher/broker's own best interest. In other words, the service clients do not have the ability to dictate receipt of a set of providers based on criteria that the service clients define.

Another issue with conventional matcher/brokers is that the service clients are at a disadvantage in determining the reliability of a service provider. Service clients' sole option is to interact with different brokers and match-makers individually. In a digital economy, trust can often be violated and misused often resulting in high transaction costs, inefficiencies and less than optimal service client experience dealing with middle men. Brokers can promote service providers that generate the highest advertising fees instead of service providers that are the best match for the service client. Similarly, the broker may find any service client for the service provider instead of selectively guiding it towards the service clients that are best suited for it. In general, brokers and matchers are looking out for their own best interests, instead of the best interests of the service providers or the service clients. This is a flaw in the online broker/matcher model.

Conventional matcher/broker applications fail to user-based management of the reputation of the service clients and service providers. Many matcher/broker applications provide service providers with tools to downgrade or eliminate poor reviews. The result being that service clients are unable to determine the reliability of provided reviews. Additionally, conventional matcher/broker architecture do not provide a method or intermediary to resolve disputes and handle payments.

Turning now to an overview of the aspects of the invention, one or more embodiments of the invention address the above-described shortcomings of the prior art by providing a peer-to-peer network that matches service providers and service clients based upon service provider and service client dictated schema.

Embodiments of the present invention comprise a decentralized peer-to-peer network of service client subsystems and service provider subsystem. Each subsystem is connected through a network which enables communications to occur between any pair of subsystems. In this distributed environment without a central broker/matcher, the format used by service clients and service providers can be different which makes processing requests difficult. To address this, service requests can be made self-describing by embedding a reference to a document schema. The schema is a file which describes how the contents are structured (e.g., Hypertext Markup Language (HTML), extensible markup language (XML), extensible hypertext markup language (XHTML), JavaScript Object Notation (JSON) or a listing of the names of attributes that are used within the document). The schemas are given a fixed name and the schema is signed by a hash of a public key of the service client. Given the name, the schema can be retrieved by means of any file sharing peer to peer network.

In embodiments of the present invention, each participant in the system also maintains an online reputation, which is a rating for the service provided to one or more clients. Each rating is signed by the service client providing it, and it includes a verifiable identification of the service client. Furthermore, as there is no central broker, the online rating is not skewed or altered in favor of service providers who pay a fee to a central broker.

Embodiments of the present invention provide a method for recording agreements and financial transaction between service providers and clients. In some embodiments of the present invention, upon acceptance by a provider, the client and the service provider can enter into a smart contract which is stored in a blockchain through the system. The peer-to-peer network is enabled with blockchain technology to permit clients and service providers to enter into a and record a smart contract. The smart contracts are self-executing agreements encoded into blocks of a blockchain and enable the client and service provider to enter the agreement without the necessity of a middle man or third party.

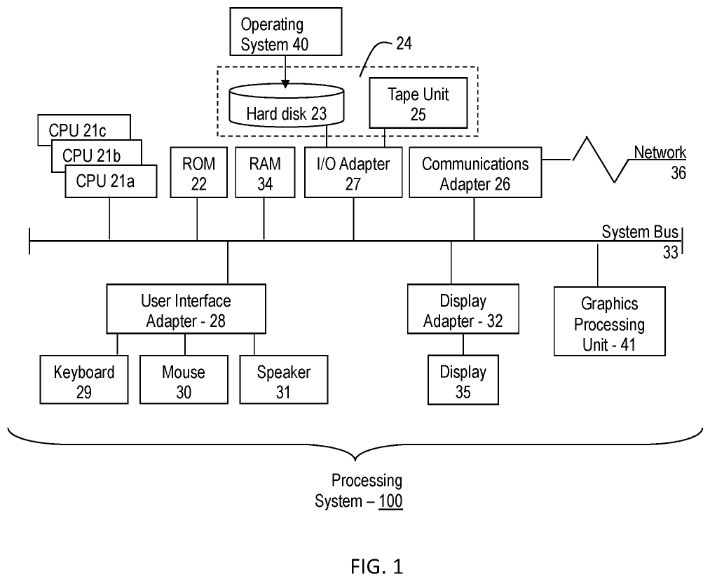

Turning now to a more detailed description of aspects of the present invention, referring to FIG. 1, there is shown an embodiment of a processing system 100 for implementing the teachings herein. In this embodiment, the system 300 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 and various other components via a system bus 33. Read only memory (ROM) 22 is coupled to the system bus 33 and may include a basic input/output system (BIOS), which controls certain basic functions of system 100.

FIG. 1 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 100 may be stored in mass storage 24. A network adapter 26 interconnects bus 33 with an outside network 36 enabling data processing system 100 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 all interconnected to bus 33 via user interface adapter 28, which may include, for example, a Super I/O chip integrating multiple device adapters into a single integrated circuit.

In exemplary embodiments, the processing system 100 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel.

Thus, as configured in FIG. 1, the system 100 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system coordinate the functions of the various components shown in FIG. 1.

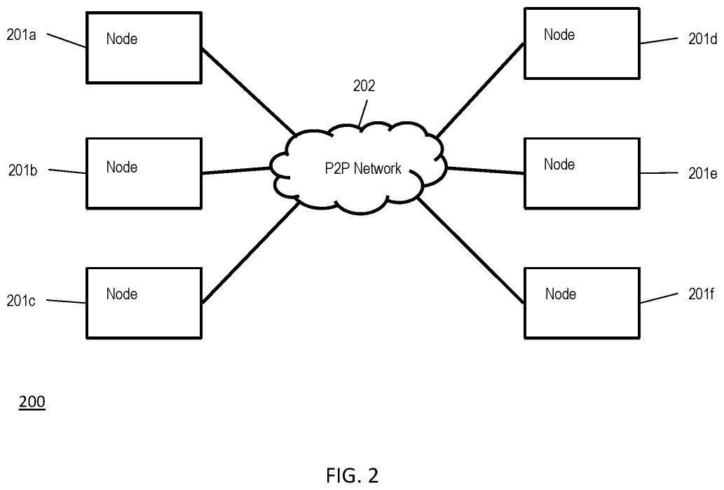

FIG. 2 sets forth a block diagram of a generalized peer-to-peer network 200 according to embodiments of the present invention. The network of FIG. 2 includes a plurality of nodes 201a-201f connected by a peer-to-peer network 202. A node 201 is any computing device capable of supporting hardware and software that may be propagated according to embodiments of the present invention and capable of data communications with other nodes in a peer-to-peer network. For example, a node can be the system 100, as described above.

Each node 201 in the generalized peer-to-peer network provides a portion of their resources to the other nodes 201 within the network, without the need for a traditional central server to provide coordination or direct transference of data or files without central coordination from servers or stable hosts. Each node in the peer-to-peer network is both a supplier and a consumer of resources. It should be noted that although the peer-to-peer network, as depicted in FIG. 2, presents six connected nodes, the network can include any number of connected nodes greater than 2.

Peer-to-peer networks are embodied through various architectural structures including unstructured and structured networks. In an unstructured peer-to-peer network, the network is not optimized or organized by an overlay or algorithm. The network is formed through random connections between peers. Unstructured peer-to-peer networks further include pure peer-to-peer networks, hybrid peer-to-peer networks, and centralized peer-to-peer networks. In a pure peer-to-peer network all nodes have equal performance capabilities and no one node or set of nodes performs any governing function for the network. Peers who want to access a file send requests directly to other nodes without an intervening node.

In a hybrid peer-to-peer network, one node or a set of dedicated nodes have specialized functions similar to a central server in a client-server network. Each peer node in the network connects to one of these specialized server nodes. These server nodes maintain an index of all peers in the network including IP addresses, port numbers, node identification information, and bandwidth characteristics. The server nodes also maintain a list of files each peer has available for transfer to another peer. The server nodes exchange information between each other without involving other peer nodes. Peers who want to access a file send requests to the server nodes. The server nodes then search their database to determine if a peer node has the file and returns a list of peers to the requesting node. The requesting node then directly requests the file from the nodes from the list. The server nodes are also equipped with security protocols that enable them with the ability to accept or reject prospective network peers.

A centralized peer-to-peer network utilizes a bifurcated system of peer nodes and super nodes. The network dynamically assigns and reassigns peer nodes to be super nodes based upon processing power and bandwidth. In other words, if the supernodes become inactive, the network assigns other peer nodes to become the supernodes. The network does not inform the peer that is has been assigned or removed as a supernode. Each supernode provides server type functionality for a subset of nodes of the entire peer-to-peer network. The supernodes maintain an index of peers, files contained at each peer, and files being transferred. Peers who want to access a file send requests to the supernodes. The supernodes then search their database to determine if a peer has the file and return a list to the requesting node. The requesting node then directly requests the files with nodes from the list.

A structured peer-to-peer network utilizes a global overlay or algorithm to ensure that each peer node can request and receive a file transfer from another peer node. Structured peer-to-peer networks commonly employ distributed a hash table (DHT) systems, in which ownership of files is assigned to individual peers. Peers can directly search keys, pairs, and values from a distributed hash table to determine the owner of a requested file. The peer nodes can directly request a file from nodes on the list.

As seen in FIG. 2, the peer nodes are connected via a network 201. Each peer node will be equipped with a communication interface, for example, a communications port, a wired transceiver, a wireless transceiver, and/or a network card to access the network. The network can provide communication between peer nodes by using technologies such as Ethernet, fiber optics, microwave, xDSL (Digital Subscriber Line), Wireless Local Area Network (WLAN) technology, wireless cellular technology, BLUETOOTH technology and/or any other appropriate technology.

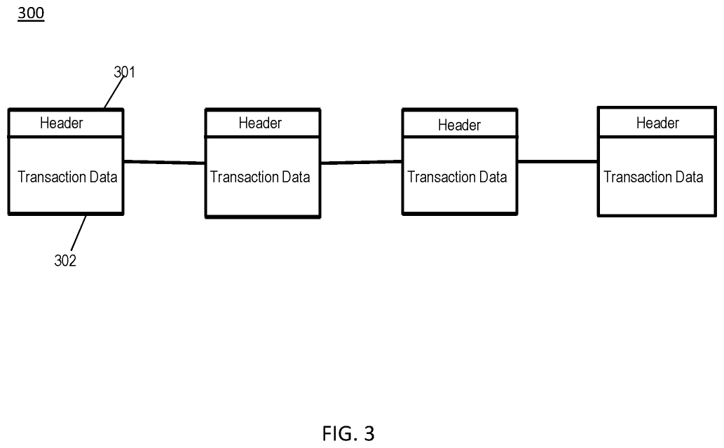

FIG. 3 depicts a diagram of an exemplary blockchain 300. A blockchain 300 is computer-based distributed ledger comprised of individual blocks connected in a chain. Each block is comprised of a block header 301 and transactional data 302. In general, a block header 301 contains metadata describing the version of the block chain, a cryptographic hash of the previous block, a root hash describing each transaction contained in the block, a timestamp, a difficulty setting for mining the block, and a nonce value. The block hash value is derived from an encryption algorithm that converts a series of input numbers and letters into an encrypted output having a fixed length.

Each successive block comprises a hash pointer as a link to a previous block, thereby creating the chain. Due to the difficulty of mining a block, the integrity of the data contained in each block is resistant to bad actors attempting to modify or delete data. For this reason, a blockchain is suitable system for recording transactions or executing smart contracts between suppliers and clients.

Embodiments of the present invention employ blockchain code to record agreements between service clients and service providers. These smart contracts can be stored on a public database and are resistant to unauthorized change or modification as described above. The smart contracts are also self-executable upon the occurrence of terms and conditions agreed upon by the parties. The blockchain can record the terms of the agreement as well a record of any financial transaction between the parties. The decentralized nature of these agreements as well as the public nature of the recordings can reduce the necessity of middle men and transactional costs.

For example, a service provider can agree to sell a product or perform a service for a service client. The terms of the agreement can be encoded and stored within the blockchain. The service client can deposit funds into a third-party account. As the service provider satisfies its obligations under the contract, funds can be automatically released from the third-party account to the service provider. The release of funds can be automatically recorded and stored in the blockchain.

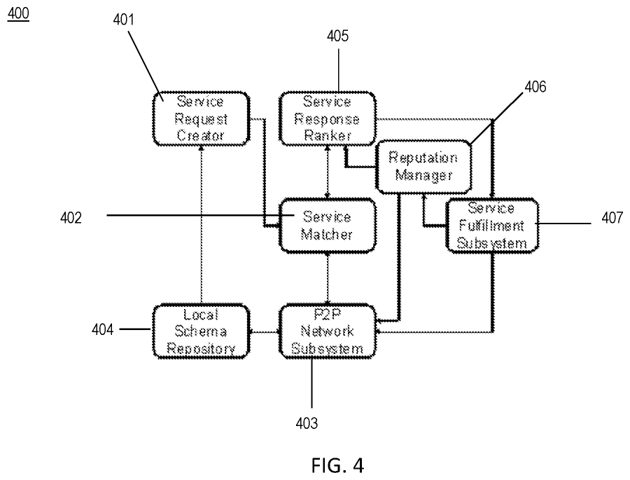

FIG. 4 sets forth a block diagram of a service client subsystem 400 connected to a peer-to-peer network 403 according to embodiments of the present invention. A service request creator 401 enables a peer to define a request (e.g., airline tickets, computer service technician, rental properties, etc.) with specific fill-in fields and an embedded reference to schema. A peer can access the service request creator through an input output device including a keyboard 29, mouse 30, and a speaker 31. A service matcher 402 takes the request and sends it to the peer-to-peer network system 403. The peer-to-peer network system 403 connects to other peer-to-peer network systems 402. Each service client node also contains a local repository of schemas 404. A schema describes how a service request is structured and has a unique identifier. The service client selects the identifier of the schema and signs it with a private key and a hash of the schema including the public key, which is included as part of the schema.

The service matcher 402 transmits a service request to the peer-to-peer network subsystem 403 and waits for a response from one or more service providers. The service matcher 402 can either wait until a predetermined number of matches are returned or wait until a predetermined time has expired. Upon receiving a response or responses, the service matcher 402 sends any received responses to a service response ranker 405. The service response ranker 405 selects the best suited responses to the service request and sends them to the service fulfillment subsystem 407. The service response ranker 405 selects the best suited responses based upon a pairing of service client-initiated criteria, service provider offerings, and reputation rating. The service response ranker 405 communicates with a reputation manager 406 to incorporate the respective reputation values of each responding service provider into the recommendations to the service client. Upon a decision by the service client, the service fulfillment subsystem 407 notifies the selected service provider node that it has been selected, and executes any steps required to complete the service matching. These steps include exchanging contact information between the client and provider, initiating a smart contract, and notifying the other services providers that they were not chosen.

The local schema repository 404 enables a service request client and a service provider to communicate through a single schema. For example, a client may wish to retain a handyman, for a specific date and location. The client accesses the client software on his or her computing device and indicates the need for a handy man. The service client node transmits a request and embeds a reference to each schema in the local schema repository. The handymen can respond using the appropriate schema and include fill-in fields necessary to evaluate the request. The requested fill-in fields can include client identification, worksite location, description of labor involved, budget, special notes, and a client timeline.

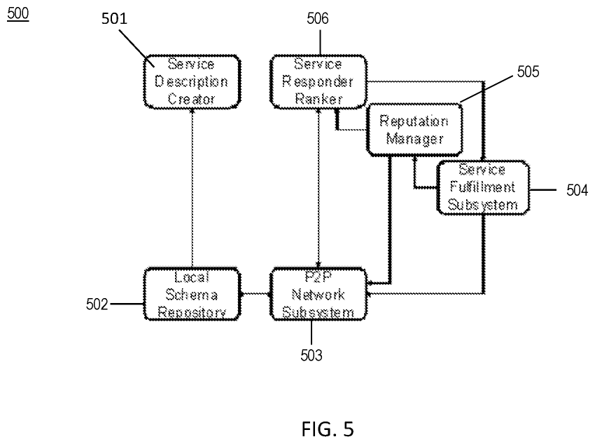

FIG. 5 sets forth a block diagram of a service provider subsystem 500 connected to a peer-to-peer network according to embodiments of the present invention. The service descriptor creator 501 creates a description of a provided service using a schema. Each service provider node contains a local repository of schemas 502. The schema can be an existing one that is used for this purpose, or it can be a new one created by the service provider node. The service responder node monitors its peer-to-peer network subsystem 503 for service requests and initiates a response from the respective provider. Once the service responder finds a confirmed request, it will pass it to the service fulfillment subsystem 504. Upon completion of a service, the service fulfillment subsystem 504 receives a ranking from a service client. This ranking is transmitted to a reputation manager 505 which synthesizes the rankings to generate a ranking for the service provider. This ranking is transmitted to a respective service responder ranker 506. The service responder ranker transmits the ranking to the service response ranker 405 upon a matching between a service client and a service provider.

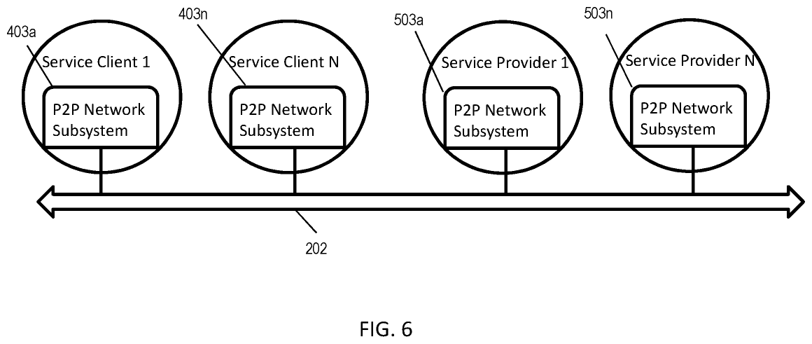

FIG. 6 sets forth a block diagram of a matching peer-to-peer network according to embodiments of the present invention. All the nodes in the system are connected together into one global network using their peer-to-peer network subsystems 403a . . . 403n and 503a . . . 503n. The general structure of all service providers and service clients can be logically represented as a fully connected system with many providers and clients, which can communicate with each other via a variety of techniques. The service client nodes 403a . . . 403n and the service provider nodes 503a . . . 503n are connected via a network 202, as described above.

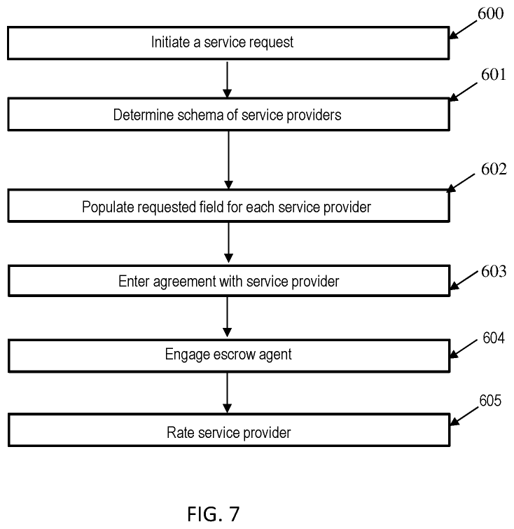

FIG. 7 depicts a flow diagram of a method for a service client to match with a service provider according to one or more embodiments of the invention. The method includes initiating a service request by the service the client 600. In embodiments of the present invention, the service client node searches all connected peer-to peer networks to determine under which schema service providers can receive a request 601. The service client matches available service provider schema with schema available in the local schema repository 404. The service provider subsystem can also import additional schema to accommodate a service provider's schema. The service client node presents the client with each fill-in field for each service provider in a compatible schema. The client populates each fill-in field and transmits the requests to each respective service provider 602.

In embodiments of the invention, the request is transmitted with embedded references to all schema available by the service client. The service provider subsystem then determines the compatibility of service request schema. The service provider subsystem is enabled with a local schema repository 502, which contains a plurality of schema to choose from. The service provider subsystem can also import additional schema to accommodate a service client request. The service provider subsystem can transmit a request for proposal to the service client and indicate which filed to be provided. The service client node presents the client with each fill-in field for each service provider in a compatible schema. The client populates each fill-in field and transmits the requests to each respective service provider.

In embodiments of the present invention, the parties enter into an agreement with an escrow agent. The escrow agent is responsible for ensuring that a transaction completes successfully between a service client and a service provider. When the service request is sent out, the service client can send out a set of escrow service providers that it is willing to accept, just as a service provider can maintain a list of escrow providers it is willing to accept. The parties agree to one escrow agent from proposed by the other party. The escrow agent receives funds from the service client (either complete or a part of the payment) before the service is initiated and releases the funds upon approval of the service client. The escrow service can also provide a rating to the client and providers on each service interaction.

In the service selection phase, both the service client and the service provider can define policies as to the steps to take when they cannot find a mutually acceptable service provider. Such policies may indicate that they may be willing to risk fulfilling a service if the service provider has a higher rating, or if the service provider has a reputation ranking from someone in the network that they trust.

Upon completion of the service or termination of the agreement, the service client rates the service provider based upon performance 605. The reputation manager system 405, 505 keeps track of the reputation ratings. Each reputation/ranking provided in this manner contains the identity of the person providing the reference, as well as the rating which is signed by the public key of the participant. This allows anyone in the network to verify the rating that is claimed. In embodiments of the invention, the ratings of different parties can be put into a distributed ledger such as hyper-ledger of another instantiation of a distributed ledge implementation based on block-chain. In other embodiments of the invention, the person can validate the reputation by selecting a subset of the entities who have provided references to a provider, and then validate the reference by contacting them.

Additional processes may also be included. It should be understood that the processes depicted in FIG. 7 represent illustrations, and that other processes may be added, or existing processes may be removed, modified, or rearranged without departing from the scope and spirit of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In embodiments of the invention, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system for distributed decentralized matching, the system comprising:
a processor communicatively coupled to a memory, the processor configured to:
transmit, through a peer-to-peer network, a service request to a plurality of service provider nodes;
receive, from at least one service provider node, a service offer response;
retrieve a compatible schema between the service client node and the service provider node; and
display, in a compatible schema, a list of each service offer response to a service client.

2. The system of claim 1, wherein the processor is further configured to embed, in the service request, references to each schema available to a client service node.

3. The system of claim 1, wherein the processor is further configured to:
determine a schema compatible with the at least one service provider node; and
transmit the service request in the compatible schema.

4. The system of claim 1, wherein the processor is further configured to:
display, to the service client, requested fill-in fields from a service provider; and
enable the service client to populate the requested fill-in fields.

5. The system of claim 1, wherein the processor is further configured to manage a computer-based distributed ledger, wherein the computer-based distributed ledger comprises a record of service requests, service offer responses, and smart contracts entered into by the service client and any service providers.

6. The system of claim 1, wherein the processor is further configured to enable the service client to enter a reputation rating for a service provider.

7. The system of claim 6, wherein the processor is further configured to display a ranked list of each service offer response to the service client.

8. The system of claim 1, wherein the processor is further configured to:
transmit a list of escrow agents to a service provider;
receive a list of escrow agents from a service provider; and
enable both the service client and service provider to choose a common escrow agent.

9. The system of claim 1, wherein the peer-to-peer network comprises an unstructured peer-to-peer network.

10. The system of claim 9, wherein the unstructured peer-to-peer network comprises a hybrid peer-to-peer network.

11. The system of claim 9, wherein the unstructured peer-to-peer network comprises a centralized peer-to-peer network.

12. The system of claim 1, wherein the peer-to-peer network comprises a structured peer-to-peer network.

13. A computer program product for distributed decentralized matching, the computer program product comprising a computer readable storage medium having program instructions executable by a processor to cause the processor to a method comprising:
transmitting, through a peer-to-peer network, a service request to a plurality of service provider nodes;
receiving, from at least one service provider node, a service offer response;
retrieving a compatible schema between the service client node and the service provider node; and
displaying, in a compatible schema, a list of each service offer response to a service client.

14. The computer program product of claim 13, the method further comprising embedding, in the service request, references to each schema available to a client service node.

15. The computer program product of claim 13, wherein the method performed by the processor further comprises:
determining a schema compatible with the at least one service provider node; and
transmitting the self-describing service request in the compatible schema.

16. The computer program product of claim 13, wherein the method performed by the processor further comprises managing a computer-based distributed ledger comprising a record of self-describing service requests, service offer responses, and smart contracts entered into by the service client and any service providers.

17. The computer program product of claim 13, wherein the method performed by the processor further comprises enabling the service client to enter a reputation rating for a service provider.

18. A computer-implemented method for distributed decentralized matching, the method comprising:
transmitting, through a peer-to-peer network, a service request to a plurality of service provider nodes;
receiving, from at least one service provider node, a service offer response;
retrieving a compatible schema between the service client node and the service provider node; and
displaying, in a compatible schema, a list of each service offer response to a service client.

19. The computer-implemented method of claim 18 further comprising enabling a service client to enter a reputation rating for a service provider.

20. The computer-implemented method of claim 18 further comprising:
transmitting a list of escrow agents to a service provider;
receiving a list of escrow agents from a service provider; and
enabling both the service client and service provider to choose a common escrow agent.
